(19) United States
(12) Patent Application Publication
(10) Pub. No.: US 2014/0012590 A1
(43) Pub. Date: Jan. 9, 2014

(54) System and Method for Inter-Relating Multiple Data Types

(71) Applicants: David Warren Badger, Wellington, FL (US); Dale G. Benner, Pennsburg, PA (US); Elizabeth Ann Waldman, New Hope, PA (US); Girish Marathe, Mumbai (IN); Marjory Beth Herron, Green Cove Springs, FL (US); Steven L. Dewitt, Philadelphia, FL (US); Gary Trinh, Lafayette, PA (US); David J. Stover, East Greenville, PA (US); Luis Soria, Englewood, NJ (US)

(72) Inventors: David Warren Badger, Wellington, FL (US); Dale G. Benner, Pennsburg, PA (US); Elizabeth Ann Waldman, New Hope, PA (US); Girish Marathe, Mumbai (IN); Marjory Beth Herron, Green Cove Springs, FL (US); Steven L. Dewitt, Philadelphia, FL (US); Gary Trinh, Lafayette, PA (US); David J. Stover, East Greenville, PA (US); Luis Soria, Englewood, NJ (US)

(21) Appl. No.: 10/537,474

(22) PCT Filed: Dec. 6, 2002
(86) PCT No.: PCT/US02/39248

§ 371 Date: Apr. 9, 2013

(51) Int. Cl. G06Q 50/22; G06Q 30/02

(52) U.S. Cl. CPC G06Q 50/22; G06Q 30/0201
USPC 705/2

(57) ABSTRACT

A system and method of inter-relating multiple data types to provide a comprehensive data output reflecting non-retail sales of pharmaceuticals is disclosed. In particular, the system and method of the present invention provides for receiving non-retail pharmaceutical delivery information of pharmaceuticals deliver to outlets from manufacturers or distributors, where the data is primarily inconsistent and features many voids (102, 104, 202-204). The present invention inter-relates one or more reference datum from other sources (402-412) in a cross relational manner to ensure that voided fields in the pharmaceutical deliver information are populated and/or verified (414). The present invention also provides means to configure pre-defined queries of the data extract for efficient service of reports for clients (416).

### FIELD OF THE INVENTION

The present invention is directed to techniques for inter-relating multiple data types, and, in particular, to the manipulation and inter-relation of various types of data to create a augmented comprehensive data output.

### BACKGROUND INFORMATION

The pharmaceutical industry is one of the largest income generating industries in the world. However, there are a great number of pharmaceutical companies producing the same or equivalent drugs. Thus, it has become increasing important for these manufacturers to be able to generate data indicating their market share in various geographic regions, as well as the quantity of specific drugs sales in each area.

At present, manufacturers are able to monitor their retail sales with reasonable accuracy. Retail sales are essentially drug sales to retail stores (“retail outlets”), such as the commonly known “drug store.” These retail sales are fairly traceable because the data relating to the deliveries to retail outlets is kept in great detailed.

With this comprehensive data, multiple reports and analysis may be conducted. These reports can be used, for example, to help a manufacturer determine in which geographic regions to focus their efforts to retain or gain market power, determine which physicians to send pharmaceutical samples, and which regions to target due to under performance. The ability to track and trace these retail sales does indeed assist the manufacturers greatly, however, retail sales do not represent the total pharmaceutical market.

A significant portion of the pharmaceutical market involves “non-retail sales.” Non-retail sales are most notably drug sales terminating in hospitals, departments in hospitals, clinics and in individual physician offices (“non-retail outlets”). For example, when a person is admitted to a hospital for surgery, many drugs are dispensed to that patient, i.e., anti-inflammatory drugs, infection preventative medication, etc., from within the hospital's own inventory. Data for drugs delivered to the non-retail outlets, for patient consumption, is not maintained in any consistent manner and certainly is not as comprehensive as the data received relating to deliveries to retail outlets. Hospitals and other non-retail outlets are under no requirement to provide data of the same magnitude as the retail outlets. Further, the non-retail portion of the market is comprised of a complex matrix of non-retail outlets, many of which are affiliated with a common umbrella organization which may or may not do the ordering for multiple non-retail outlets falling thereunder.

Thus, the situation exists where a non-retail outlet may be a key purchaser of an expensive drug, a fact a pharmaceutical company would surely want to know in order to better cater to that non-retail outlet and physicians affiliated therewith, yet appear not to be such a purchaser because the data relating to the deliveries to the non-retail outlet does not exist in a comprehendible form. Thus, it is difficult to get a clear understanding of the respective market shares of drug purchases from pharmaceutical manufacturers, and regional analysis of the above. Accordingly, there exists a need for a technique to provide comprehensive record information of pharmaceutical sales to non-retail outlets.

### OBJECTS AND SUMMARY OF THE INVENTION

An object of the present invention is to receive pharmaceutical delivery information pertaining to the sales of pharmaceuticals, from manufacturers and other distributors to non-retail outlets, and augment the pharmaceutical delivery information by inter-relating one or more reference datum, where the reference datum shares at least one cross relational property with the pharmaceutical delivery information.

It is a further object of the present invention to provide for multiple un-related types of reference datum, where the reference datum provides more detailed information than that originally contained in the non-augmented pharmaceutical delivery information.

In order to achieve these objectives, as well as others which will become apparent in the disclosure below, the present invention provides techniques for the manipulation and inter-relation of various types of reference datum to pharmaceutical delivery information (“the extract”) to create a comprehensive data output of pharmaceutical sales/deliveries to non-retail outlets. Non-retail sales/delivery data may be received on a weekly or monthly basis (“the extract”) from a number of manufacturers or distributors. Manufacturers or distributors supply pharmaceutical delivery information that may display sales/delivery of pharmaceuticals to a plurality of non-retail outlets. The majority of such data is wholly inadequate for any type of meaningful analysis and at most provides a unique code of an outlet which received a delivery, as a consequence of an order placed with a manufacturer or distributor; the pharmaceutical delivered; the zip code of the outlet the pharmaceutical was delivered; date of delivery; and the quantity. Since such data are not uniform and fairly un-useful in its native form, the present invention provides a technique which adapts to perform a complex inter-relationship, together with predictive modeling, to better populate the extract, such that the extract becomes as comprehensive and usable as the retail sales data.

In a preferred embodiment, the extract is inter-related with reference datum that includes an exhaustive list of non-retail outlets and facilities.

In another preferred embodiment, the extract is inter-related with reference datum that includes an exhaustive list of facilities and individual physicians that are affiliated with those facilities. Preferably, this inter-relation is performed after the above inter-relation of the exhaustive list of non-retail outlets and facilities with the extract.

In yet another preferred embodiment, the extract is inter-related with reference datum that includes postal zip code information relating to the facilities. Advantageously, where a facility is known for a given non-retail outlet, the postal zip code for the facility is provided from the reference datum. The extract may be updated accordingly. Where a facility for a non-retail outlet is not known, a virtual facility for the zip code in which the non-retail outlet sits is created and deliveries/sales to that outlet are associated with the virtual facility. The virtual facility may advantageously be used as a placeholder until an actual facility to outlet relationship is available for one or more non-retail outlets.

In yet another preferred embodiment, the extract is inter-related with reference datum that includes diagnosis-treatment information. This data set may provide a cross reference between a pharmaceutical and diagnosis, e.g., cancer. Further, other types of reference datum may be used to be inter-related with the extract.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of the basic process flow of prescription drugs in the pharmaceutical industry;

FIG. 2 is an illustration of the hierarchy of non-retail sales organizations in the pharmaceutical industry;

FIG. 3 is a system diagram in accordance a preferred embodiment of the present invention;

FIG. 4 is a flow diagram of the technique of augmenting the pharmaceutical delivery information in accordance with a preferred embodiment of the present invention; and

FIG. 5 is an example of pharmaceutical delivery information and the inter-relation with reference datum in accordance with a preferred embodiment of the present invention.

### DESCRIPTION OF AN EXEMPLARY EMBODIMENT

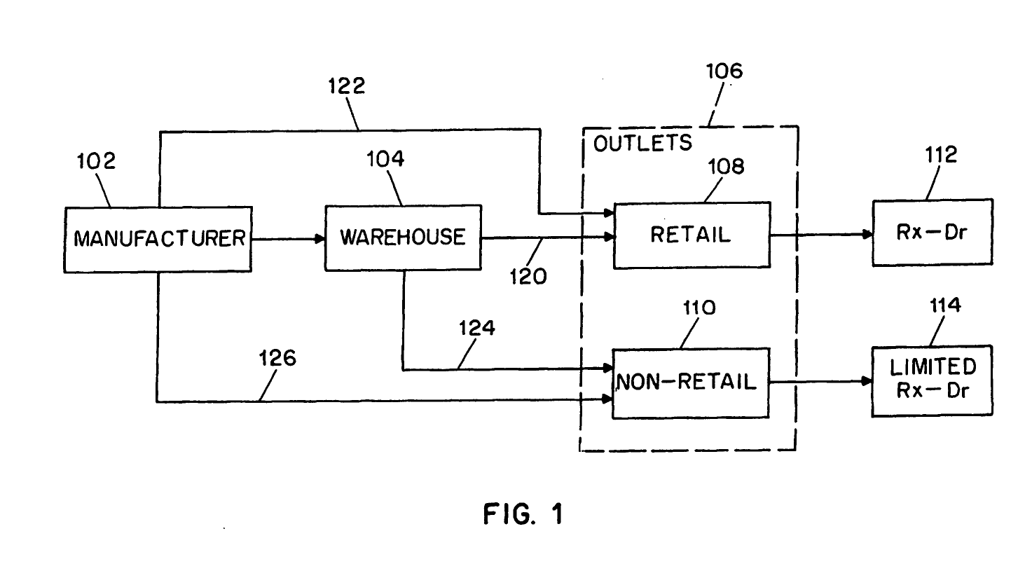

FIG. 1 illustrates the basic process flow of drugs in the pharmaceutical industry. A pharmaceutical industry manufacturer 102 or warehouse 104 (also referred to herein as “distributor”) supplies pharmaceuticals directly to a plurality of outlets 106. Outlets 106 may be retail outlets 108 or non-retail outlets 110. Pharmaceuticals from a manufacturer 102 or warehouse 104 may be delivered to retail outlets 108, such as the commonly known “drug store”, which are subsequently dispensed to patients in accordance with prescriptions 112 written by individual physicians, as illustrated in lines 120, 122. Pharmaceuticals from a manufacturer 102 or warehouse 104 may also be delivered to non-retail outlets 110, where non-retail outlets, as defined above may include hospitals, departments with hospital, medical clinics, individual physician offices, etc., as illustrated in lines 124, 126, for filling prescriptions prescribed and filled therein.

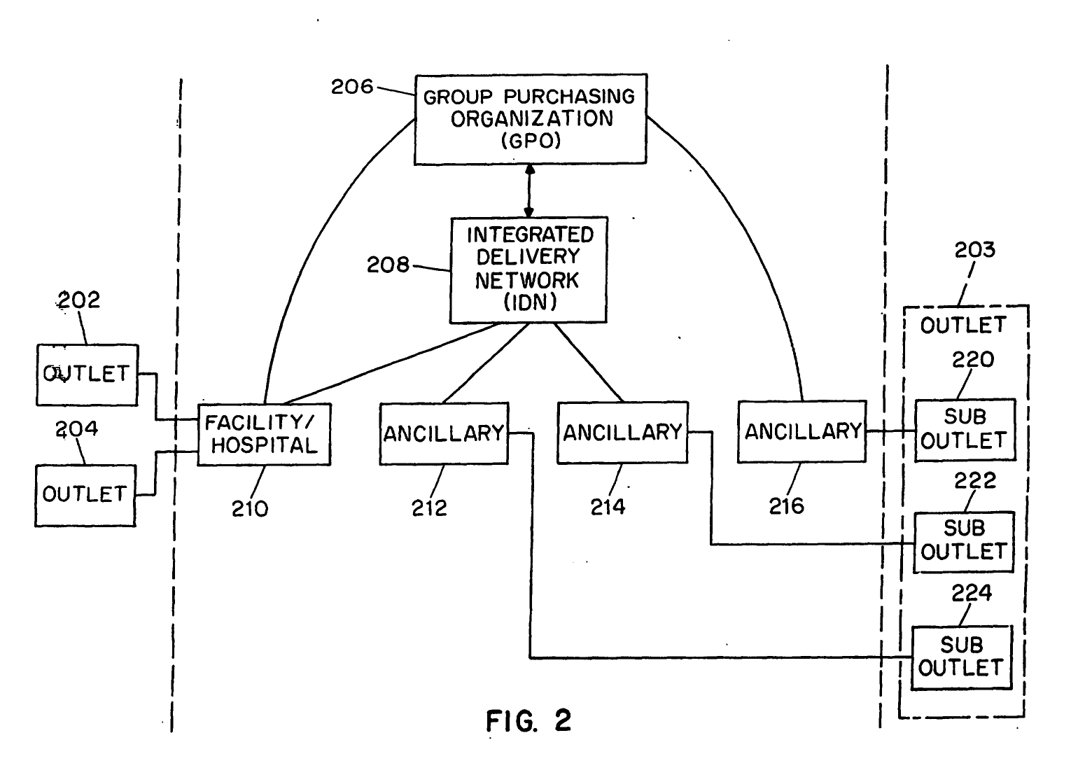

Referring to FIG. 2, a series of non-retail outlets 202, 203, 204 are associated with a facility 210 or other ancillary unit 212, 214, 216. A facility 210, or ancillary unit 212, 214, 216, is a logical grouping of non-retail outlets 202, 203, 204 for purposes of statistical analysis. For example, a facility could be New York University (“NYU”) Medical Center, where non-retail outlets include NYU's Oncology Department, NYU's Maternity Department, and NYU's Pediatric Department. Such a grouping provides for easy analysis of large medical groups/settings.

A facility 210, or ancillary unit 212, 214, 216 may be affiliated with an integrated delivery network (“IDN”) 208. An IDN 208, in turn, may be affiliated with a pharmaceutical group purchasing organization (“GPO”) 206. Any of the above organizations may order and/or purchase pharmaceuticals from a manufacturer 102 or distributors 104 for non-retail outlets 202, 203, 204, including the non-retail outlets 202, 203, 204 themselves.

The manufacturers 102 and distributors 104 provide the reporting data regarding the pharmaceuticals delivered to non-retail outlets 202, 203, 204. This data may arrive in a variety of manners and depth. Thus, there is no consistency in this reporting.

Some reports simply state the drugs delivered, to a non-retail outlet, quantity, and the non-retail outlet's zip code.

The system and method of the present invention “fills the gaps” in the data set provided by the manufacturers 102 and distributors 104, as well as provides a more detailed data picture by inter-relating the data received relating to the deliveries to the non-retail outlets 202, 203, 204 with multiple other reference datum types.

Further, referring to non-retail outlet 203, a non-retail outlet 203 may contain a plurality of sub-outlets 220, 222, 224. This is most common where one physical address, e.g., a medical center building, contains multiple doctor offices or other clinics. The sub-outlets 220, 222, 224 provide for differentiation between these entities physically at the same address.

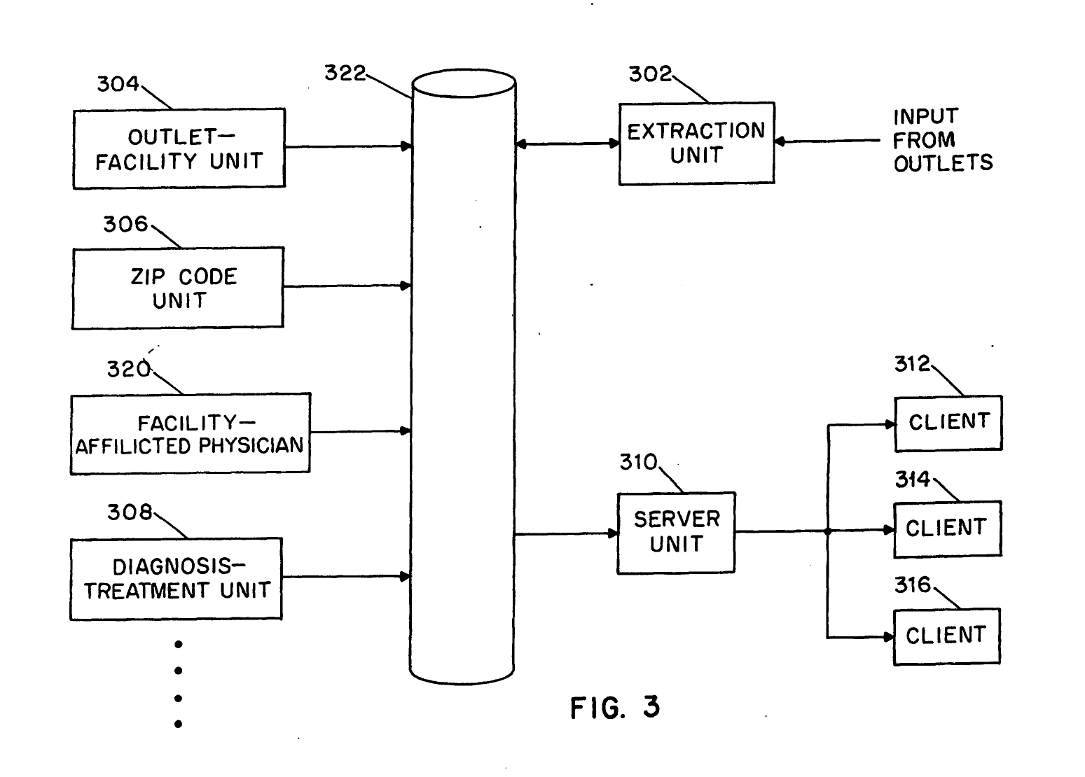

Referring to FIG. 3, an exemplary embodiment of the present invention will be described below. In the exemplary embodiment, an extraction unit 302 receives pharmaceutical delivery information, also described herein as the extract as indicated above, from manufacturers 102 and distributors 104. The extract data, which at a minimum may only contain a code for an outlet, delivered pharmaceutical, and quantity, receives reference datum from one or more reference data units 304, 306, 308, 320. Reference data units may include an outlet-facility unit 304, zip code unit 306, facility-affiliated physician unit 320, diagnosis-treatment unit 308, or other reference data unit which cross reference at least one type of data in the extract. Further, after the inter-relation of one or more reference datum, described below, the system and method of the present invention preferably displays aspects of the augmented extract to users via clients 312, 314, 316 which are served such data from server unit 310, described below.

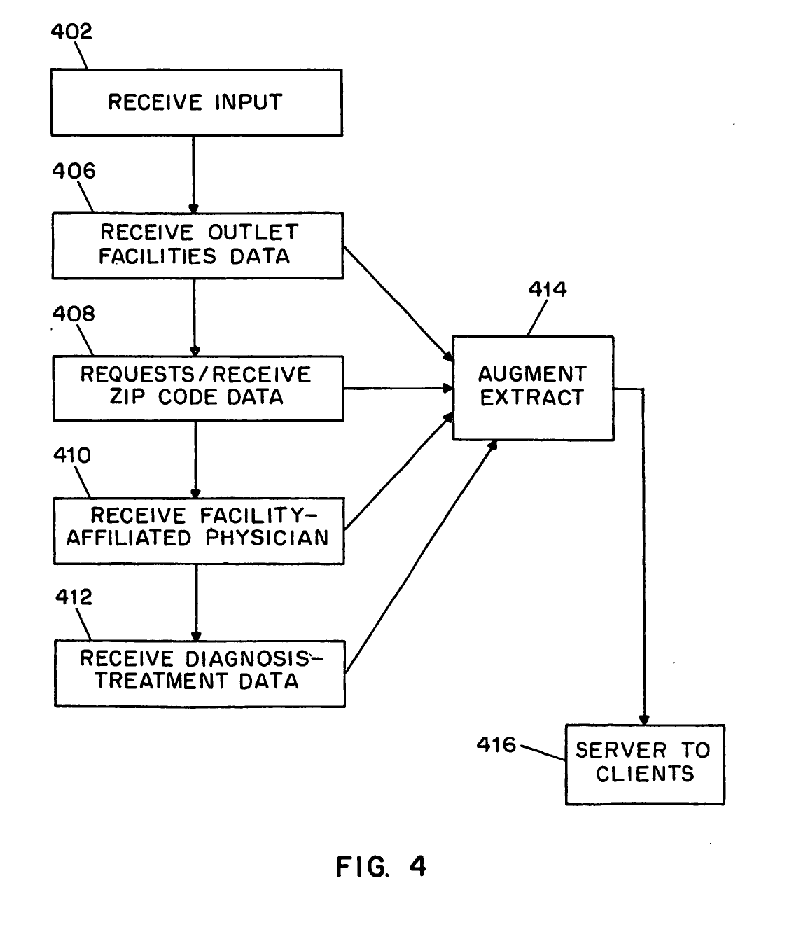

Referring to FIG. 4, in operation the extraction unit 302 first receives the extract (input data) from the manufacturers 102 and distributors 104 in step 402. Then in step 406 the extraction unit 302 receives reference datum from the outlet-facility unit 304 that pertains to the relationships between outlets and facilities. For example, outlets “001”, “002”, “003”, and “004”, respectively referring to NYU's Oncology Department, NYU's Maternity Department, NYU's Pediatric Department, and Dr. John Doe Office, all are related the NYU Medical Center (“NYCMC”) facility. Thus, the outlet-facility unit 304 provides the matrix of relationships across outlets and facilities. In this way, a subsequent query of the NYU Medical Center facility may be accurately performed.

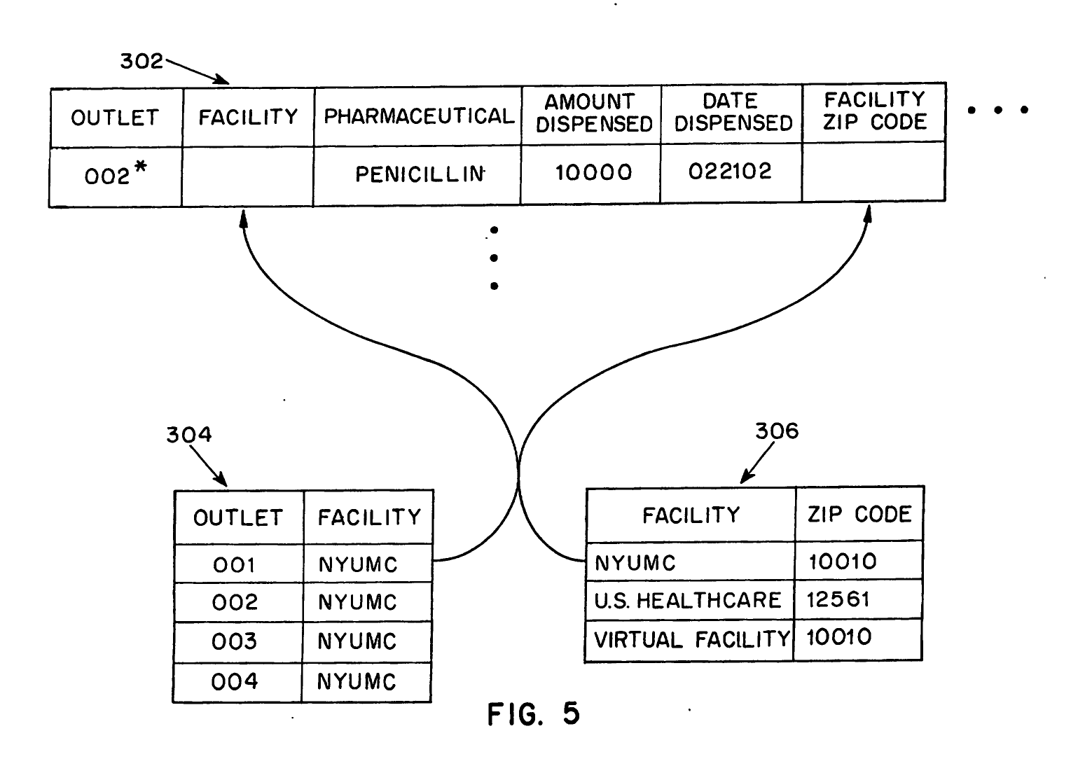

Referring to FIG. 5, which contains an example of a data record in the extract, in accordance with an exemplary embodiment, the extract is augment by the extraction unit 302 inter-relating like data types to populate unknown data types in the extract. In the example, the “facility” data is void because the extract does not contain facility information.

Thus, the extraction unit 302 looks up the outlet reference number, “002”, in the reference datum, which reveals that outlet “002” is affiliated or part of the NYU Medical Center Facility. The extraction unit 302 then attempts to provide a zip code for the NYU Medical Center facility. So the extraction unit 302 then preferably requests data from other reference data units. In this example, in step 408 the extraction unit 302 requests postal zip code data from zip code unit 306 to populate the facility zip code field. Further, in a preferred embodiment, if a non-retail outlet in the outlet-facility database does not have a facility associated with it, but a known valid zip code for the outlet is in the data record, a virtual facility is created and all sales data relating to such outlet(s) is related to the virtual facility. A virtual facility, or the sales data related thereto, may be augmented with actual facility data at a later point in time. Here, since the outlet “002” relates to the NYUMC facility, such problem has not been encountered. The data record in the extract is modified accordingly.

In a preferred embodiment of the present invention, this type of cross relational matching is performed to modify the extract to populate the maximum amount of data fields. Further, the extraction unit 302 may be adapted to include the ability to interpolate, also called predictive modeling, sales to sub-outlets 220, 222, 224 based upon prior mapping relations. For example, if in 99 out of 100 instances penicillin delivered to outlet 203 was actually delivered to sub-outlet 220, and the outlet delivery data for the 100th order of penicillin delivered to outlet 203 lacks sub-outlet delivery information, the system can assume the 100th instance was delivered to sub-outlet 220.

After extraction unit 302 inter-relates the reference data from the outlet-facility unit 304 and zip code unit 306, in step 410 the present system and method inter-relates the augmented extract with facility-affiliated physician data via the facility-affiliated physician unit 320. In this step the extraction unit 302 uses the same type of inter-relation as described above by populating a “physician” field in the extract by keying in on the facility.

Thereafter, in step 412 the present system and method preferably inter-relates the augmented extract with diagnosis-treatment data via the diagnosis-treatment unit 308. The diagnosis-treatment unit 308 is a reference data unit that may contain an accurate list of diagnosis and pharmaceuticals used to treat said diagnosis. In this way, a pharmaceutical prescribed can be inter-related with one or more diagnosis. This inter-relationship is important because it can help a manufacturer determine which facilities and/or outlets to target for advertisement of a particular drug based upon the most common medical use.

Thus, the drugs are keyed on in the extract and populated with diagnosis data where available.

Based upon the reference data received and the data already in the extract data record, the extract may be augmented after the reception of one type of reference datum or may need to wait until the reception of multiple types of reference datum. In this way, augmenting the extract in step 414 may be performed multiple times and at varied times.

After the extract is augmented by all available reference datum, the extract is ready to be queried. With so many query options and data from multiple manufacturers and distributors, efficiency as well as security concerns are apparent. To counter balance the efficiency concerns, queries are written into the system, as requested by manufacturers, in a pre-defined manner. Thus, the present system and method may execute a pre-defined query at off-peak usage hours, e.g., overnight, and the results of said predefined queries can be pre-generated such that the presentation of the reporting data to clients may be facilitated in an efficient manner. Since the extract data is at best updated weekly, stale data will not result. In terms of security, the extraction unit 302 preferably only allows a client, where one or more clients are affiliated with a unique manufacturer, to view the results of queries requested by that client's affiliated manufacturer. In a preferred embodiment, the queries requested by a manufacturer are constrained by specific confidential rules. Such confidentially rules may include that (1) a manufacturer may not formulate a query of data related to the specific sales of a particular pharmaceutical produced by a competitive manufacturer; (2) a manufacturer may formulate a query to see the trend of a particular pharmaceutical produced by a competitive manufacturer, where a trend is simply one of a “up,” “down” or “no activity” indicator, illustrating if a particular pharmaceutical from a competitive manufacturer has exceed a predefined fixed percentage threshold set by the querying manufacturer; and/or (3) a manufacturer may be permitted to formulate a query relating to the specific sales of a particular pharmaceutical if such query requests a grouping of sales data of three or more competitive manufacturers in a form where individual manufacturer data cannot be parsed. Preferably, a manufacturer may also be permitted to formulate a query of sales data related to a particular pharmaceutical for a competitive manufacturer only if such particular pharmaceutical is queried at a territory level, where a territory includes multiple zip codes, and where such territory include a minimum predefined number of non-retail outlets in such territory. This is simply the first level of security. In addition to this level of security, the clients preferably have unique login information to properly identify and authenticate the end users. Clients 312, 314, 316 are served with the reporting data via server 310 (also see step 416 of FIG. 4).

Extraction unit 302, outlet-facility unit 304, zip code unit 306, facility-affiliated physician unit 320, diagnosis-treatment unit 308, and server unit 310 communicate and pass data over data bus 322. Data bus 322 also comprises a database for the caching of data, when needed as between the above aforementioned units.

The above system and method may be implemented by many computer languages commonly known in the art and may operate on many computer platforms which include both volatile and non-volatile memory storage devices. In a preferred embodiment, the system and method of the present invention is implemented, in whole or in part, in a multi-tiered architecture consisting of a mainframe computer and distributed network servers, including Unix and windows web servers. Software code encapsulating the functionality of the present inventive technique may be implemented on such computer systems, preferably written in COBOL, SAS, JCL, C, C++, Kom/Unix Shell, ASP, and/or Visual Basic. Preferably data and the results of the data queries are stored in one or more relational databases, which provide resultant data to a graphical user interface (“GUI”), where the GUI features a presentation layer included therein. Further, the system and method of the present invention, as described above, may alternatively be implemented on transportable media, preferably a CD-ROM.

Although the invention has been described herein by reference to an exemplary embodiment thereof, it will be understood that such embodiment is susceptible of modification and variation without departing from the inventive concepts disclosed. All such modifications and variations, therefore, are intended to be encompassed within the spirit and scope of the appended claims.

1. A system for inter-relating pharmaceutical delivery information with one or more reference datum, comprising:
an input for receiving said pharmaceutical delivery information from a manufacturer or distributor of pharmaceuticals;
a reference data unit storing said one or more reference datum, said reference datum sharing at least one cross relational property to said pharmaceutical delivery information;
an extraction unit, coupled to said input and receiving pharmaceutical delivery information therefrom, and coupled to said reference data unit and receiving said one or more reference datum therefrom, for augmenting said pharmaceutical delivery information in order to provide pharmaceutical delivery information with inter-related reference datum.

2. The system of claim 1, wherein said reference data unit comprises an outlet-facility unit for providing relationship information between an outlet and a facility, said extraction unit receiving said relationship information and augmenting said pharmaceutical delivery information to include said relationship information with said facility.

3. The system of claim 2, wherein said extraction unit uses interpolation to augment said pharmaceutical delivery information based upon said relationship information of prior purchases of pharmaceuticals contained in said pharmaceutical delivery information, said pharmaceuticals being delivered to sub-outlets.

4. The system of claim 2, wherein said reference data unit comprises a zip code unit providing postal zip code pertaining to said facility.

5. The system of claim 2, wherein said reference data unit comprises a zip code unit providing a virtual facility for a zip code for one or more outlets in said zip code which are not related to an actual facility.

6. The system of claim 2, wherein said reference data unit comprises a facility-affiliated physician unit providing physician information between facilities and physicians practicing in said facilities, said extraction unit receiving said physician information and augmenting said pharmaceutical delivery information to include said physician information.

7. The system of claim 1, wherein said reference data unit comprises a diagnosis-treatment unit providing a cross reference between pharmaceuticals and medical diagnosis, said extraction unit receiving said cross reference and augmenting said pharmaceutical delivery information to include said cross reference information.

8. The system of claim 7, wherein said data from said diagnosis-prescription unit is retrieved from an external database.

9. The system of claim 1 further comprising a server unit, said server unit providing reports to clients, said reports generated from pre-defined queries.

10. The system of claim 1, wherein said extract data is received weekly.

11. (canceled)

12. A method for inter-relating pharmaceutical delivery information with one or more reference datum, comprising:
receiving an input comprising pharmaceutical delivery information;
receiving one or more reference datum, said reference datum sharing at least one cross relational property to a data type in said pharmaceutical delivery information; and
augmenting said pharmaceutical delivery information by inter-relating said data type in said pharmaceutical delivery information with said one or more reference datum in order to provide pharmaceutical delivery information with inter-related reference datum.

13. The method of claim 12, wherein said step of receiving said one or more reference datum comprises receiving data pertaining to a relationship between an outlet and a facility.

14. The method of claim 13, wherein said step of receiving said one or more reference datum comprises receiving zip code data pertaining to said facility.

15. The method of claim 14, wherein said zip code is an actual postal zip code.

16. The method of claim 13, wherein said step of receiving said one or more reference datum comprises receiving a virtual facility to relate to an outlet, said virtual facility being associated with an actual zip code.

17. The method of claim 12, wherein said step of receiving said one or more reference datum comprises receiving data pertaining to a relationship between facilities and physicians.

18. The method of claim 12, wherein said step of receiving said one or more reference datum comprises receiving diagnosis-treatment data, said diagnosis-treatment data comprising the inter-relationship between a pharmaceutical and at least one diagnosis.

19. The method of claim 18, wherein said diagnosis-treatment data is retrieved from an external database.

20. The method of claim 12 further comprising transmitting reports generated from queries of said pharmaceutical delivery information to clients.

21. The method of claim 12, wherein said extract data is received weekly.

22. (canceled)
